(19) United States
(12) Patent Application Publication
(10) Pub. No.: US 2024/0351232 A1
(43) Pub. Date: Oct. 24, 2024

(54) Electronic Cutting Machine

(71) Applicant: Proasia Holdings Ltd, Kowloon Bay (HK)

(72) Inventor: Alex Co, Seattle, WA (US)

(21) Appl. No.: 18/662,665

(22) Filed: May 13, 2024

Related U.S. Application Data
(63) Continuation-in-part of application No. 29/874,608, filed on Apr. 21, 2023.
(60) Provisional application No. 63/501,992, filed on May 12, 2023.

(51) Int. Cl. B26D 7/26; B26D 7/00

(52) U.S. Cl. CPC B26D 7/265; B26D 2007/0087; B26D 2007/2671

(57) ABSTRACT

An electronic cutting machine for cutting preprogrammed shapes into paper. The electronic cutting machine utilizes a cutter assembly carrying a blade to move across the paper, making precise cuts in the paper. The electronic cutting machine utilizes a first motor connected to a set of rollers to maneuver the paper being cut relative to the cutter assembly. The electronic cutting machine utilizes a second motor to maneuver the cutting assembly across the paper. The electronic cutting machine is enclosed within an outer shell. The inner components of the electronic cutting machine are accessible through a front door.

### FIELD OF THE INVENTION

The present invention relates generally to electronic cutting machines and more specifically to apparatuses for automatically cutting patterns and designs into materials on a two-axis layout.

### BACKGROUND OF THE INVENTION

Electronic cutting machines are commonly used for patterns and designs made from a multitude of materials for art projects, crafting, and other purposes that require precise cuts of flat material. Many electronic cutting machines currently available operate on a large scale, having large and intricate components and combinations of components, as well as being bulky overall. Further, many currently available cutting machines operate inefficiently in the multidirectional movement required for cutting intricate patterns into a sheet of material, in some cases leading to mechanical failures.

The present invention is an electronic cutting machine intended for home use that uses a combination of specific components to result in a small-scale cutting machine that efficiently and effectively cuts material within a compact environment.

### SUMMARY OF THE INVENTION

The present invention is an electronic cutting machine for cutting preprogrammed shapes into paper. The electronic cutting machine utilizes a cutter assembly carrying a blade to move across the paper, making precise cuts in the paper. The electronic cutting machine utilizes a first motor connected to a set of rollers to maneuver the paper being cut relative to the cutter assembly. The electronic cutting machine utilizes a second motor to maneuver the cutting assembly across the paper. the cutter assembly is supported by support shafts. The electronic cutting machine is enclosed within an outer shell. The inner components of the electronic cutting machine are accessible through a front door, which is pivotably attached to the outer shell.

### BRIEF DESCRIPTION OF THE DRAWINGS

FIG. 1 is a top front isometric view of the cutting machine of the present invention in accordance with at least one embodiment.

FIG. 2 is a top front isometric view of the cutting machine of the present invention in accordance with at least one embodiment.

FIG. 3 is a top front isometric view of the cutting machine of the present invention without the shell and front door in accordance with at least one embodiment.

FIG. 4 is a top rear isometric view of the cutting machine of the present invention without the shell and front door in accordance with at least one embodiment.

FIG. 5 is a top front isometric view of a sub-assembly of the cutting machine of the present invention in accordance with at least one embodiment.

FIG. 6 is a front elevation view of the cutting machine of the present invention without the shell and front door in accordance with at least one embodiment.

FIG. 7 is a side elevation view of the cutting machine of the present invention without the shell and front door in accordance with at least one embodiment.

FIG. 8 is a side elevation view of the cutting machine of the present invention without the shell and front door in accordance with at least one embodiment.

FIG. 9 is a top front isometric view of the cutter assembly of the present invention in accordance with at least one embodiment.

FIG. 10 is a front elevation view of a portion of the cutter assembly of the present invention in accordance with at least one embodiment.

### DETAILED DESCRIPTION OF THE INVENTION

All illustrations of the drawings are for the purpose of describing selected versions of the present invention and are not intended to limit the scope of the present invention.

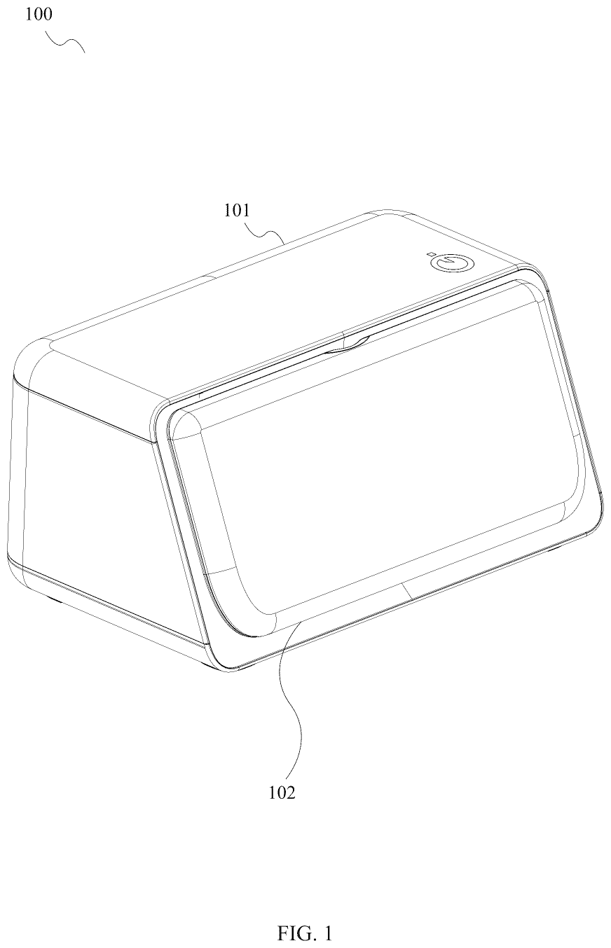

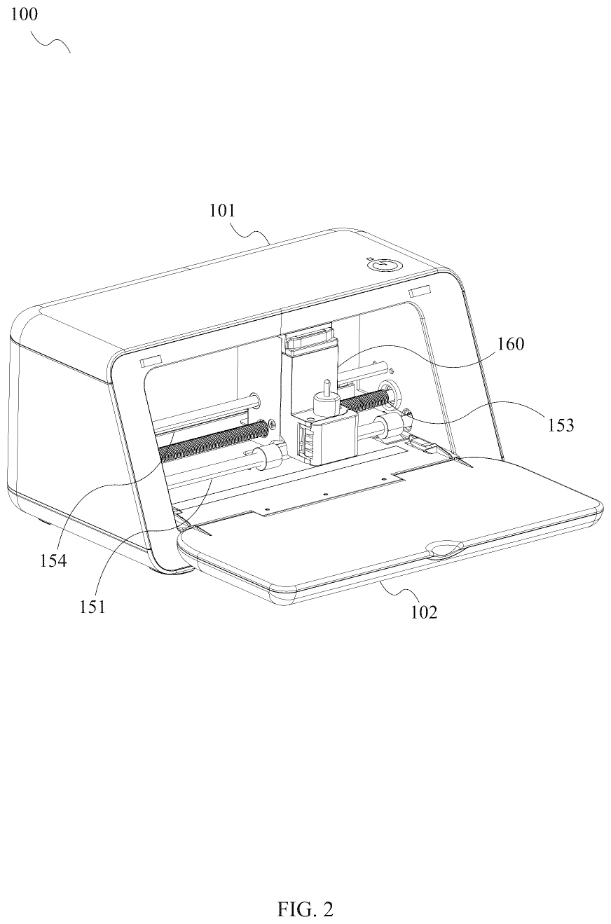

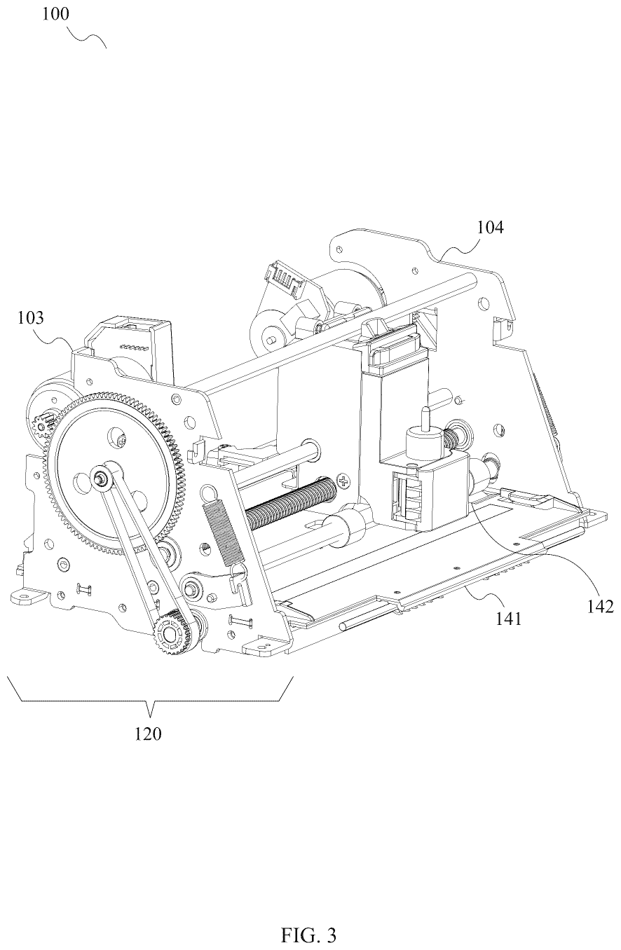

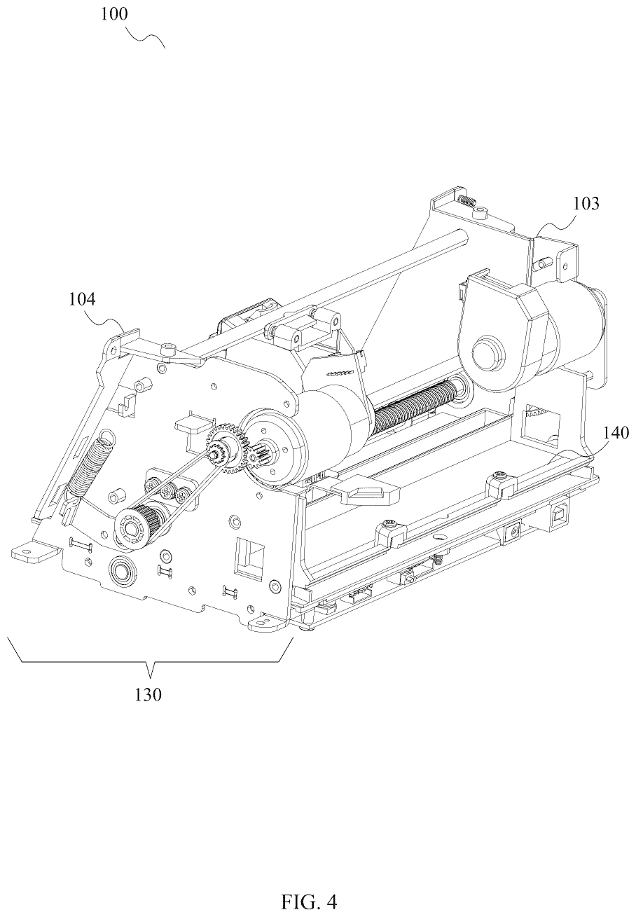

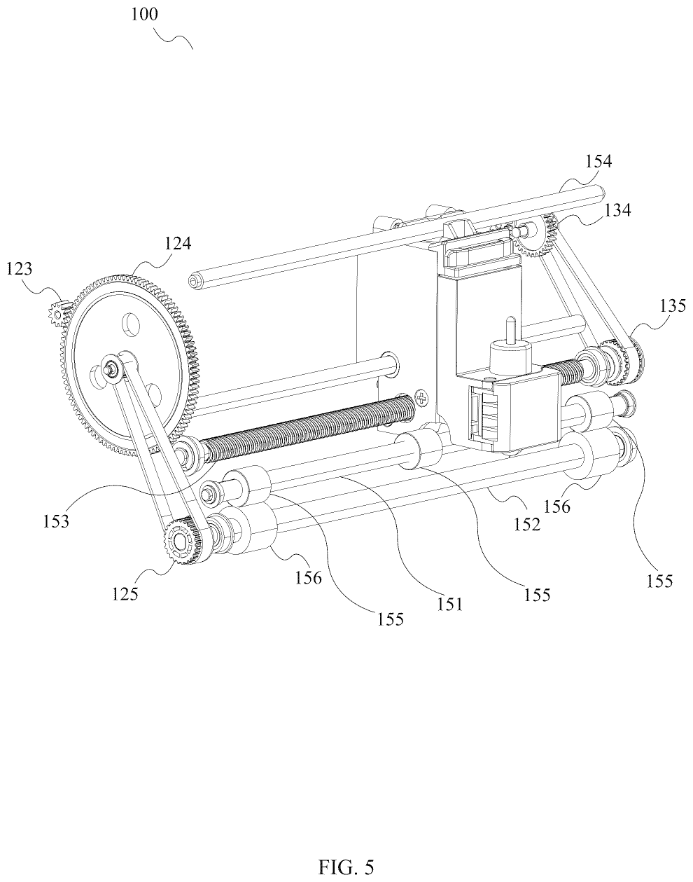

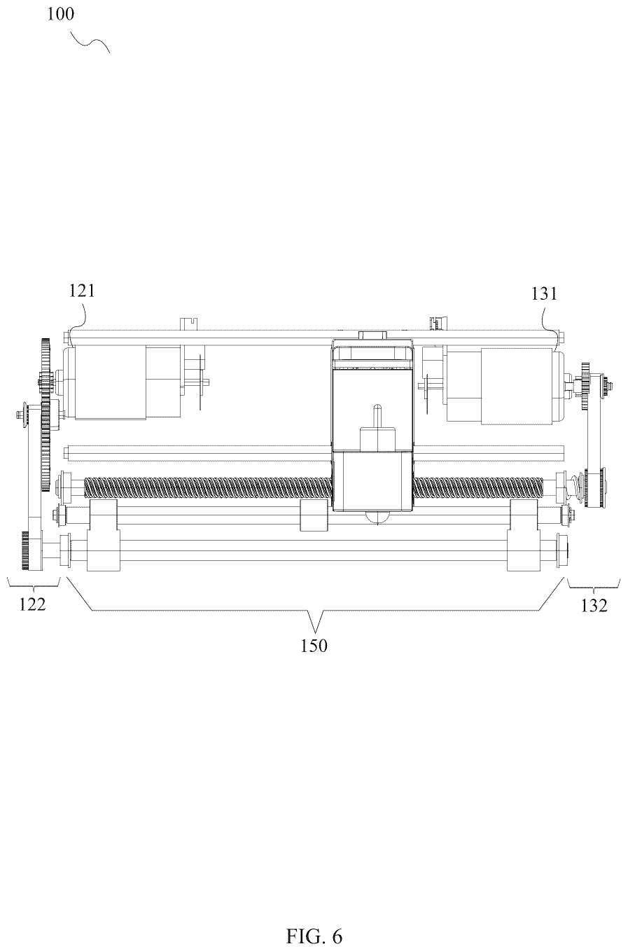

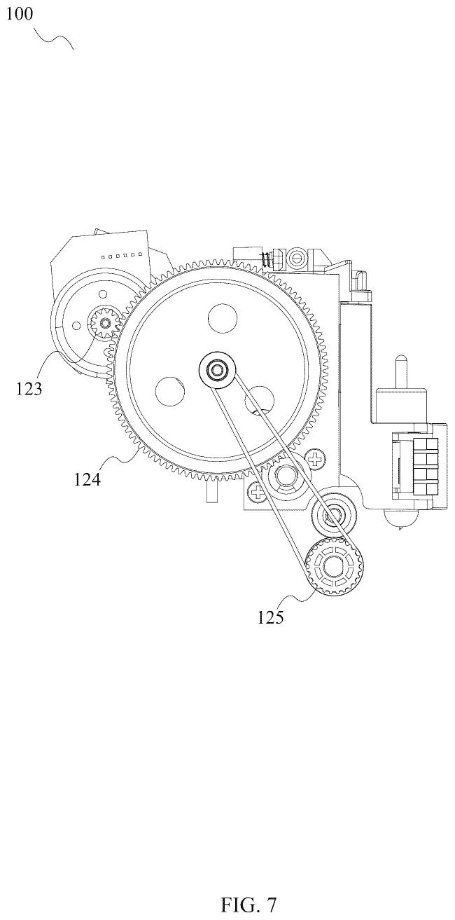

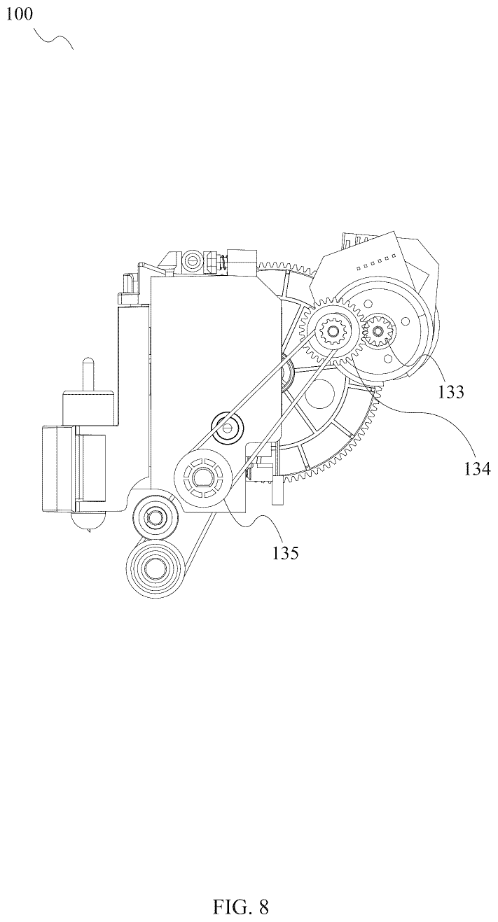

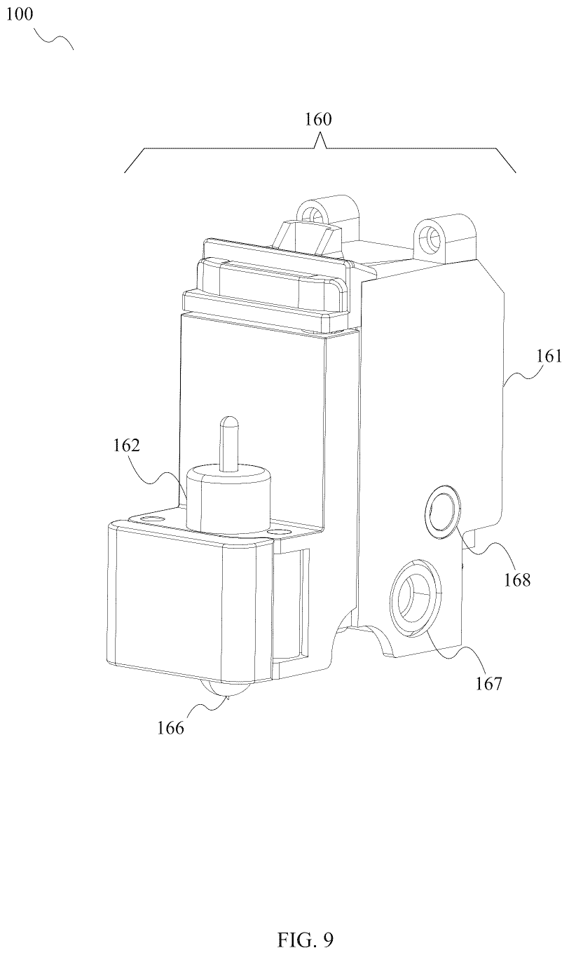

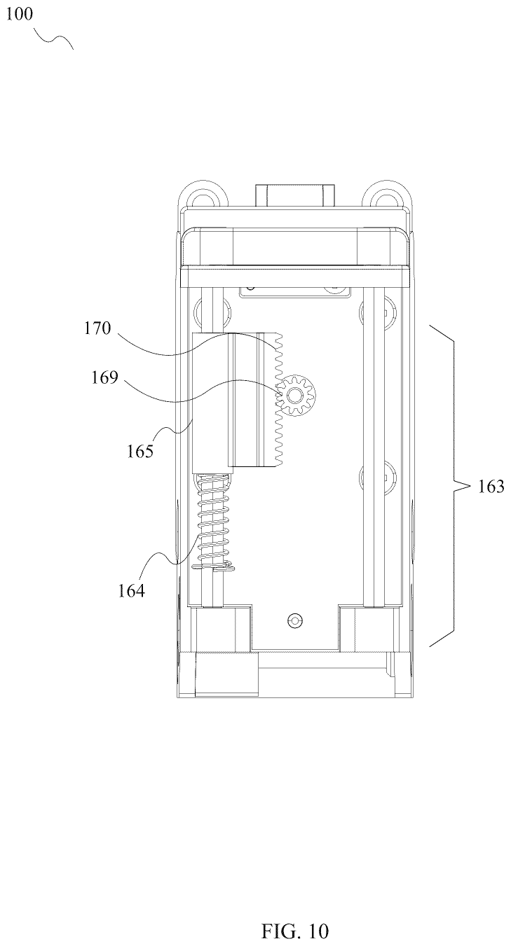

Referring to FIGS. 1-10, the present invention is an electronic cutting machine 100 configured to cut sheets of materials into desired shapes, designs, and patterns. The electronic cutting machine 100 comprises an outer shell 101, a front door 102, a first frame 103, a second frame 104, a first motor assembly 120, a second motor assembly 130, a cutting surface 140, a plurality of shafts 150, and a cutter assembly 160. The first frame 103, the second frame 104, the first motor assembly 120, the second motor assembly 130, the plurality of shafts 150, and the cutter assembly 160 are arranged within the outer shell 101, accessible through the front door 102. The first motor assembly 120 and second motor assembly 130 may be oppositely positioned about the plurality of shafts 150 and the cutting surface 140 with the cutter assembly 160 being adjustably arranged on the plurality of shafts 150.

The outer shell 101 and the front door 102 are configured to contain the other components of the electronic cutting machine 100, protecting components having fragile or fine-tuned pieces from dust and debris or external damage. The outer shell 101 is preferably a rectangular prism, having a hollow interior area and one open end. The front door 102 is attached to the outer shell 101 on the open end, covering the open end and restricting access to the interior area. The front door 102 is configured to be moved away from the open end of the outer shell 101, allowing a user to access the interior area of the outer shell 101. In the preferred embodiment, the front door 102 is pivotably attached to the outer shell 101 on one end, allowing the front door 102 to swing away from the outer shell 101, exposing the interior area of the outer shell 101.

The first motor assembly 120 is arranged within the outer shell 101 and mounted to the first frame 102. The first motor assembly 120 is configured to control at least one of the plurality of shafts 150. The first motor assembly 120 comprises a first motor 121 and a plurality of first gears 122. The plurality of first gears 122 may comprise a first primary gear 123, a first secondary gear 124, and a roller gear 125. The first motor 121 is configured to provide rotation to the plurality of first gears 122 and at least one of the plurality of shafts 150. The first motor 121 is configured to selectively rotate both clockwise and anticlockwise. In the preferred embodiment, the first motor 121 is connected to the first primary gear 123, the first primary gear 123 is connected to the first secondary gear 124, the first secondary gear 124 is connected to the roller gear 125, and the roller gear 125 is connected to the lower roller shaft 152. Any two gears of the plurality of first gears 122 may be directly connected to one another by interlocking gear teeth or may be connected to one another by a belt or similar apparatus. In the preferred embodiment, each gear of the plurality of first gears 122 may be a different size, allowing for differing speed, torque, and control from the first motor to the plurality of shafts 150. Ultimately, either directly by the first motor 121 or through the plurality of first gears 122, the first motor assembly 120 is configured to rotate at least one of the plurality of shafts 150.

The second motor assembly 130 of the present invention is arranged within the outer shell 101 and mounted to the second frame 104. The second motor assembly 130 is configured to control at least one of the plurality of shafts 150. The second motor assembly 130 comprises a second motor 131 and a plurality of second gears 132. The plurality of second gears 132 may comprise a second primary gear 133, a second secondary gear 134, and a spiral gear 135. The second motor 131 is configured to provide rotation to the plurality of second gears 132 and at least one of the plurality of shafts 150. The second motor 131 is configured to selectively rotate both clockwise and anticlockwise. In the preferred embodiment, the second motor 131 is connected to the second primary gear 133, the second primary gear 133 is connected to the second secondary gear 134, the second secondary gear 134 is connected to the spiral gear 135, and the spiral gear 135 is connected to the spiral shaft 153. Any two gears of the plurality of second gears 132 may be directly connected to one another by interlocking gear teeth or may be connected to one another by a belt or similar apparatus. In the preferred embodiment, each gear of the plurality of second gears 132 may be a different size, allowing for differing speed, torque, and control, from the second motor to the plurality of shafts 150. Ultimately, either directly by the second motor or through the plurality of second gears 130, the second motor assembly 130 is configured to rotate at least one of the plurality of shafts 150.

The plurality of shafts 150 is a group of rods arranged between the first motor assembly 120 and the second motor assembly 130 and between the first frame 103 and the second frame 104. The plurality of shafts 150 are configured to control X and Y directional movement of the cutter assembly 160 relative to a sheet being cut. The plurality of shafts 150 may comprise an upper roller shaft 151, a lower roller shaft 152, a spiral shaft 153, and at least one support shaft 154. The X-direction of the present invention is defined as the direction in which the plurality of shafts 150 is oriented and the Y-direction of the present invention is defined as being perpendicular to the direction in which the plurality of shafts 150 is oriented.

The upper roller shaft 151 and lower roller shaft 152 are configured to control Y-directional movement of the cutter assembly 160 relative to a sheet being cut by rolling a sheet in the Y-direction. The upper roller shaft 151 comprises at least one upper roller 155 and the lower roller shaft 152 comprises at least one lower roller 156. The at least one upper roller 155 and the at least one lower roller 156 are each cylindrical components configured to roll along a sheet, pushing it in the direction of rotation. In the preferred embodiment, the lower roller shaft 152 is connected to the first motor assembly 120 by the roller gear 125, the rotation of the lower roller shaft 152 controllable by the first motor 121 while the upper roller shaft 151 is connected to the first frame 103, freely rotatable relative to the first frame 103. In alternative embodiments, the upper roller shaft 151 may be connected to the first motor assembly 120, the rotation of the upper roller shaft 151 controllable by the first motor 121 while the lower roller shaft is connected to the first frame 103, freely rotatable relative to the first frame 103. In some embodiments the upper roller shaft 151 and the lower roller shaft 152 may both be operatively connected to the first motor assembly 120, the rotation of both the upper roller shaft 151 and the lower roller shaft 152 controllable by the first motor. In such an embodiment, the upper roller shaft 151 and the lower roller shaft 152 are configured to rotate in opposite directions. A sheet being cut by the present invention is placed between the upper roller 155 and the lower roller 156, such that rotation of the upper roller shaft 151 and/or the lower roller shaft 152 moves the sheet in the Y-direction.

The spiral shaft 153 is configured to control the X-directional movement of the cutter assembly 160 relative to a sheet being cut. The spiral shaft 153 comprises a threaded spiral groove along the length of the spiral shaft 153. In the preferred embodiment, the spiral shaft 153 is connected to the second motor assembly 130 by the spiral gear 135, the rotation of the spiral shaft 153 controllable by the second motor 131. A sheet being cut by the present invention remains stationary in the X-direction with the cutter assembly 160 moving along the spiral shaft 153 in the X-direction. The spiral shaft 153 operates as a compact and efficient design for movement in the X-direction. By managing X-directional movement entirely through the rotation of the spiral shaft 153, the X-directional movement can be controlled both precisely and quickly using only a single moving part that doesn't take up significant space within the invention or interfere with other components. Further, the spiral shaft allows for fast, efficient, and precise change of direction in the X-direction since the change of direction is reliant only on reversing the direction of the second motor 131 to spin the spiral shaft 153 in the opposite direction.

The at least one support shaft 154 is configured to support the cutter assembly 160, keeping it from rotating relative to the spiral shaft 153. The at least one support shaft 154 is fixedly connected to the first frame 103, second frame 104, or to the outer shell 101.

The cutting surface 140 is a flat surface configured to hold a sheet flat between the upper roller shaft and the lower roller shaft. The cutting surface 140 may comprise a base 141 and a plurality of roller cutouts 142. The plurality of roller cutouts 142 are apertures arranged in the base 141 to allow the upper roller 155 to extend through the cutting surface 140 adjacent to the lower roller 156 or to allow the lower roller 156 to extend through the cutting surface 140 adjacent to the upper roller 155.

The cutter assembly 160 is arranged along the plurality of shafts 150, configured to move along the plurality of shafts 150 in the X-direction. The cutter assembly 160 may comprise a cutter housing 161, a cutter motor 162, a plurality of cutter gears 163, a blade pusher spring 164, a blade housing 165, and a blade 166. The cutter housing 161 is configured to contain internal components of the cutter assembly 160. The cutter housing 161 comprises a spiral opening 167 and at least one support opening 168. The spiral opening 167 is a threaded hole configured to engage with the spiral shaft 153 and the at least one support opening 168 is a hole configured to engage with the at least one support shaft 154. The cutter housing 161 is arranged on the plurality of shafts 150 with the spiral shaft 153 traversing through the spiral opening 167 and the at least one support shaft 168 traversing through the at least one support opening 168. Upon rotation of the spiral shaft 153, the cutter housing 161 moves along the spiral shaft 153 and the at least one support shaft 154 in the X-direction. The connection between the spiral opening 167 and the spiral shaft 153 causes the cutter housing to move in one direction when the spiral shaft 153 is rotated clockwise and in the opposite direction when the spiral shaft 153 is rotated anticlockwise.

The cutter motor 162 is configured to control the motion of the blade 166 by way of the plurality of cutter gears 163. The plurality of cutter gears 163 may comprise a primary cutter gear 169 and a secondary cutter gear 170. In the preferred embodiment, the primary cutter gear 169 is a circular spur gear, and the secondary cutter gear 170 is a gear rack. The primary cutter gear 169 is attached to the cutter motor 162 and engaged with the secondary cutter gear 170, converting the rotational movement of the cutter motor 169 to axial movement of the secondary cutter gear 170. The blade 166 is connected to the secondary cutter gear 170, such that upward movement of the secondary cutter gear 170 results in upward movement of the blade 166 and downward movement of the secondary cutter gear 170 results in downward movement of the blade 166. The blade 166 may be selectively arranged in an upward position and a downward position. In the downward position, the blade 166 is closer to the cutting surface 140 than in the upward position. The blade 166 is selectively moveable relative to the cutting surface 140 by the cutter motor 162 and the plurality of cutter gears 163. The secondary cutter gear 170 and the blade 166 are preferably arranged perpendicular to the spiral shaft 153 and perpendicular to the cutting surface 140, with the blade 166 extending out of the cutter housing 161. The blade pusher spring 164 may be arranged between the secondary cutter gear 170 and the cutter housing 161, limiting the movement of the secondary cutter gear 170 and the blade 166 in the direction of the cutting surface 140, creating more controlled movement between the upward position and the downward position. The blade housing 165 may be attached to the cutter housing 161, further containing the blade 166 to protect the blade 166 and prevent unsafe exposure of the blade 166 to the user.

In use, the front door 102 is opened relative to the outer shell 101, allowing access to the other components of the invention. A sheet may then be inserted on the cutting surface 140 between the upper roller 155 and the lower roller 156. The cutter assembly 160 may be repositioned relative to the sheet by using the first motor assembly 120 to rotate the upper roller shaft 151 and the lower roller shaft 152 to move the sheet in the Y-direction and by using the second motor assembly 130 to rotate the spiral shaft 153 to move the cutter assembly 160 in the X-direction. The spiral shaft 153 can be moved at various speeds and in either direction to affect the X-directional movement of the cutter assembly 160 in a quick, precise, and space-efficient manner. As the cutter assembly 160 and the sheet are moved relative to one another in the X and Y-directions, the cutter motor may be used to move the blade 166 towards and away from the cutting surface 140, cutting the sheet on the cutting surface 140 as desired. In the preferred embodiment, the control of the first motor assembly 120, second motor assembly 130, and cutter assembly 160 are preprogrammed for each use and executed by a processing device in electronic communication with the motors.

Although the invention has been explained in relation to its preferred embodiment, it is to be understood that many other possible modifications and variations can be made without departing from the spirit and scope of the invention as hereinafter claimed.

What is claimed is:

1. An electronic cutting machine, comprising:
an outer shell;
a frame;
a cutting surface;
a first motor assembly;
a second motor assembly;
a plurality of shafts;
a cutter assembly;
the outer shell containing the frame, the cutting surface, the first motor assembly,
the second motor assembly, the plurality of shafts, and the cutter assembly;
the frame connected to the plurality of shafts;
the cutting surface connected to the frame;
the first motor assembly connected to the frame;
the first motor assembly connected to the plurality of shafts;
the second motor assembly connected to the frame;
the second motor assembly connected to the plurality of shafts; and
the cutter assembly connected to the plurality of shafts.

2. The electronic cutting machine of claim 1, wherein the plurality of shafts further comprises:
a plurality of roller shafts;
a spiral shaft;
one or more support shafts;
the plurality of roller shafts connected to the first motor assembly;
the spiral shaft connected to the second motor assembly;
the one or more support shafts connected to the frame; and
the one or more support shafts connected to the cutter assembly.

3. The electronic cutting machine of claim 2, wherein the plurality of roller shafts further comprises:
an upper roller shaft;
a lower roller shaft;
the upper roller shaft connected to the frame; and
the lower roller shaft connected to the first motor assembly.

4. The electronic cutting machine of claim 1, wherein the cutter assembly further comprises:
a cutter housing;
a cutter motor;
a plurality of cutter gears;
a blade;
the cutter housing containing the cutter motor, the plurality of cutter gears, and the blade;
the cutter housing connected to the plurality of shafts;
the cutter motor connected to the plurality of cutter gears; and
the blade connected to the plurality of cutter gears.

5. The electronic cutting machine of claim 4, wherein the plurality of cutter gears further comprises:
a primary cutter gear;
a secondary cutter gear;
the primary cutter gear connected to the cutter motor;
the primary cutter gear connected to the secondary cutter gear; and
the secondary cutter gear connected to the blade.

6. The electronic cutting machine of claim 1, wherein the first motor assembly further comprises:
a first motor;
a plurality of first gears;
the first motor connected to the plurality of first gears; and
the plurality of first gears connected to the plurality of shafts.

7. The electronic cutting machine of claim 6, wherein the plurality of first gears further comprises:
a first primary gear;
a first secondary gear;
a roller gear;
the first motor connected to the first primary gear;
the first primary gear connected to the first secondary gear;
the first secondary gear connected to the roller gear; and
the roller gear connected to the plurality of shafts.

8. The electronic cutting machine of claim 1, wherein the second motor assembly further comprises:
a second motor;
a plurality of second gears;
the second motor connected to the plurality of second gears; and
the plurality of second gears connected to the plurality of shafts.

9. The electronic cutting machine of claim 8, wherein the plurality of second gears further comprises:
a second primary gear;
a second secondary gear;
a spiral gear;
the second motor connected to the second primary gear;
the second primary gear connected to the second secondary gear;
the second secondary gear connected to the spiral gear; and
the spiral gear connected to the plurality of shafts.

10. The electronic cutting machine of claim 1, wherein the cutting surface further comprises:
a base;
one or more roller cutouts; and
the base connected to the frame.

11. The electronic cutting machine of claim 1, further comprising:
a front door; and
the front door pivotably connected to the outer shell.

12. An electronic cutting machine, comprising:
an outer shell;
a first frame;
a second frame;
a cutting surface;
a first motor assembly;
a second motor assembly;
a plurality of shafts, comprising:
an upper roller shaft;
a lower roller shaft;
a spiral shaft; and
one or more support shafts;
a cutter assembly;
the outer shell containing the first frame, the second frame, the cutting surface, the first motor assembly, the second motor assembly, the plurality of shafts, and the cutter assembly;
the first frame connected to the plurality of shafts;
the second frame connected to the plurality of shafts;
the cutting surface connected to the first frame and connected to the second frame;
the first motor assembly connected to the first frame;
the first motor assembly connected to the lower roller shaft;
the second motor assembly connected to the second frame;
the second motor assembly connected to the spiral shaft; and
the cutter assembly connected to the spiral shaft and connected to the one or more support shafts.

13. The electronic cutting machine of claim 12, wherein the cutter assembly further comprises:
a cutter housing;
a cutter motor;
a plurality of cutter gears;
a blade;
the cutter housing containing the cutter motor, the plurality of cutter gears, and the blade;
the cutter housing connected to the spiral shaft and connected to the one or more support shafts;
the cutter motor connected to the plurality of cutter gears; and
the blade connected to the plurality of cutter gears.

14. The electronic cutting machine of claim 13, wherein the plurality of cutter gears further comprises:
a primary cutter gear;
a secondary cutter gear;
the primary cutter gear connected to the cutter motor;
the primary cutter gear connected to the secondary cutter gear; and
the secondary cutter gear connected to the blade.

15. The electronic cutting machine of claim 12, wherein the first motor assembly further comprises:
a first motor;
a plurality of first gears;
the first motor connected to the plurality of first gears; and
the plurality of first gears connected to the lower roller shaft.

16. The electronic cutting machine of claim 15, wherein the plurality of first gears further comprises:
a first primary gear;
a first secondary gear;
a roller gear;
the first motor connected to the first primary gear;
the first primary gear connected to the first secondary gear;
the first secondary gear connected to the roller gear; and
the roller gear connected to the lower roller shaft.

17. The electronic cutting machine of claim 12, wherein the second motor assembly further comprises:
a second motor;
a plurality of second gears;
the second motor connected to the plurality of second gears; and
the plurality of second gears connected to the spiral shaft.

18. The electronic cutting machine of claim 8, wherein the plurality of second gears further comprises:
a second primary gear;
a second secondary gear;
a spiral gear;
the second motor connected to the second primary gear;
the second primary gear connected to the second secondary gear;
the second secondary gear connected to the spiral gear; and
the spiral gear connected to the spiral shaft.

19. The electronic cutting machine of claim 12, wherein the cutting surface further comprises:
a base;
one or more roller cutouts;
the base connected to the frame; and
the lower roller shaft traversing the one or more roller cutouts.

20. An electronic cutting machine, comprising:
an outer shell;
a front door;
a first frame;
a second frame;
a cutting surface;
a first motor assembly, comprising:
a first motor; and
a plurality of first gears;
a second motor assembly, comprising:
a second motor; and
a plurality of second gears;
a plurality of shafts, comprising:
an upper roller shaft;
a lower roller shaft;
a spiral shaft; and
one or more support shafts;
a cutter assembly;
the outer shell containing the first motor assembly, the second motor assembly,
the cutting surface, the plurality of shafts, and the cutter assembly;
the front door pivotably attached to the outer shell;
the first frame connected to the plurality of shafts;
the second frame connected to the plurality of shafts;
the cutting surface connected to the first frame and connected to the second frame;
the cutting surface comprising a base and a plurality of roller cutouts;
the first motor assembly connected to the first frame;
the second motor assembly connected to the second frame;
the plurality of first gears, comprising:
a first primary gear;
a second primary gear;
a roller gear;
the first motor connected to the first primary gear;
the first primary gear connected to the first secondary gear;
the first secondary gear connected to the roller gear; and
the roller gear connected to the lower roller shaft;
the plurality of second gears, comprising:
a second primary gear;
a second secondary gear;
a spiral gear;
the second motor connected to the second primary gear;
the second primary gear connected to the second secondary gear;
the second secondary gear connected to the spiral gear; and
the spiral gear connected to the spiral shaft; and
the cutter assembly, comprising:
a cutter housing;
a cutter motor;
a primary cutter gear;
a secondary cutter gear;
a blade pusher spring;
a blade housing;
a blade;
the cutter housing containing the cutter motor, the primary cutter gear, the secondary cutter gear, the blade pusher spring, the blade housing, and the blade;
the cutter housing comprising:
a spiral opening;
a support opening;
the spiral opening connected to the spiral shaft; and
the support opening connected to at least one of the one or more support shafts;
the cutter motor connected to the primary cutter gear;
the primary cutter gear connected to the secondary cutter gear;
the secondary cutter gear connected to the blade housing;
the blade housing containing the blade; and
the blade housing connected to the blade pusher spring.
